(19) United States
(12) Patent Application Publication
(10) Pub. No.: US 2022/0193904 A1
(43) Pub. Date: Jun. 23, 2022

(54) Technique for Determining Control Information to be Wirelessly Transmitted to a Robotic Device

(71) Applicant: Telefonaktiebolaget LM Ericsson (publ), Stockholm (SE)

(72) Inventors: Sándor Rácz, Cegléd (HU); Geza Szabo, Kecskemét (HU); Bence Formanek, Budapest (HU)

(21) Appl. No.: 17/604,778

(22) PCT Filed: Jun. 12, 2019
(86) PCT No.: PCT/EP2019/065324

§ 371 Date: Oct. 19, 2021

(51) Int. Cl. B25J 9/16

(52) U.S. Cl. CPC B25J 9/1664; B25J 9/1697; G05B 2219/39216; G05B 2219/33274; B25J 9/161

(57) ABSTRACT

A controller (106) for determining control information to be wirelessly transmitted to a robotic device (102) is disclosed. The controller (106) is configured to obtain first control information comprising at least one first movement instruction for a trajectory of the robotic device (102) and obtain an indication of at least one wireless transmission requirement for a transmission resource and to determine that no wireless transmission resource is available which matches the wireless transmission requirement. The controller (106) is further configured to determine second control information based on the first control information, wherein the second control information comprises at least one second movement instruction for the trajectory which is different from the at least one first movement instruction and trigger wireless transmission of the second control information to the robotic device (102).

### TECHNICAL FIELD

The present disclosure generally relates to industrial automation. In particular, a technique for determining control information to be wirelessly transmitted to a robotic device is presented. The technique may be implemented in the form of an apparatus, a method, a computer program, a computer-readable medium, a data carrier signal, and a cloud computing system.

### BACKGROUND

Existing industrial robotic devices such as robotic arms use a closed-loop control update frequency from about 10 Hz up to the KHz range. In contrast to traditional robotic arms, where all control units are integrated parts of the robotic arm and connected over wires, modern robotic devices allow the use of remote closed-loop position, velocity and force control. Such robotic devices provide a control interface for this purpose with different control frequencies, and in this way allow different granularity/accuracy of control. For example, a robotic device may have a 10 Hz, a 125 Hz and a 500 Hz control interface.

Remote control of a robotic arm from a computing cloud over a 5^{th} Generation (5G) wireless connection is a key concept in upcoming industrial solutions. As a first step, the monitoring and predictive maintenance functionalities are moving into the cloud. In a next step, also some closed-loop control functionality is moving into cloud. In both steps, the advantage of a wireless connection is intended to be fully utilized. However, wireless closed-loop control from a remote site requires a high bandwidth, a low latency and a deterministic behavior from the wireless network.

Existing solutions for cloud-based robotic control mainly focus on monitoring and preventive maintenance, where the communication frequency is approximately in the seconds and minutes time scale. Existing closed-loop control methods for robotic arms are using a fixed update time. This is because the controller is co-located with the robotic device. The internal wired connections do not motivate any adaptation mechanism by the controller. Typically, a high update frequency is used for internal communication.

Keeping an existing high update frequency of a controller over a wireless connection results in a high bandwidth usage and high radio resource consumption for a robotic cell. In existing architectures, there is no cost of the intensive use of the internal wired connection—in case of a wireless connection the cost is proportional to the usage.

On the other hand, the use of an unnecessarily challenging wireless connection makes robotic cell operation more sensitive to radio condition disturbances like fading and generates more interference for other connections. For example, a relatively short, e.g., 5 ms, connectivity problem stops a robotic cell when a 1 ms update time and the ProfiNet protocol are used. With a longer update time, the robotic cell can continue executing commands in case of this event.

Consequently, overprovisioning a connectivity requirement of a robotic cell, i.e., using unnecessarily low update times even if higher update times would be enough from the specific robotic task point of view, degrades the overall robotic cell performance, and increases the radio resource need of the robotic cell when a wireless connection is used.

This means that in order to replace a connection used by a closed-loop control from wired to wireless, one also needs to improve controller operation.

### SUMMARY

There is a need for a technique of wirelessly transmitting control information to robotic devices that permits to cope with the uncertainties of wireless transmission channels while optimizing wireless resource usage.

According to a first aspect, an apparatus for determining control information to be wirelessly transmitted to a robotic device is provided. The apparatus is configured to obtain first control information comprising at least one first movement instruction for a trajectory of the robotic device and to obtain an indication of at least one wireless transmission requirement for a wireless transmission resource. The apparatus is further configured to determine that no wireless transmission resource is available which matches the wireless transmission requirement and to determine second control information based on the first control information, wherein the second control information comprises at least one second movement instruction for the trajectory which is different from the at least one first movement instruction. The apparatus is also configured to trigger wireless transmission of the second control information to the robotic device.

The first control information and the indication of the wireless transmission requirement may be obtained in a single message or in separate messages. In case of separate messages, the messages may be linked such that the first control information in one message can be related to the indication in another message. The indication may pertain to a transmission towards the robotic device (“downlink” direction) and/or to a transmission from the robotic device (“uplink” direction). The uplink and downlink transmission may belong to a closed-loop control of the robotic device.

The apparatus may comprise a processor configured to perform the aforementioned steps. The apparatus may be comprised in a cloud computing system. The wireless transmission resource for example is or comprises a wireless transmission channel.

In one variant, the trajectory describes a time-dependent movement of the robotic device. The at least one first movement instruction in one example comprises a first movement control command associated with a first point in time. The at least one second movement instruction may comprise a second movement control command associated with a second point in time different from the first point in time. The first or second movement control command may describe at least one of a position, a velocity and an acceleration of the robotic device associated with the first or the second point in time.

The second movement instruction may be different from the first movement instruction in that an execution time of the trajectory is changed. The execution time may become longer as a result of the second movement instruction compared to the first movement instruction. The spatial extension of the trajectory, on the other hand, may at least on some implementation not change as a result of the second movement instruction compared to the first movement instruction.

The second movement control command may, for example, describe at least one of a position, a velocity and an acceleration of the robotic device associated with the second point in time. The second point in time is in one example different from (e.g., later than) the first point in time.

The apparatus may be configured to determine that no wireless transmission resource is available which matches the wireless transmission requirement by obtaining at least one downlink wireless transmission parameter of an available wireless transmission resource on which the second control information can be transmitted. Alternatively, or in addition, the apparatus is for example configured to determine that no wireless transmission resource is available which matches the wireless transmission requirement by obtaining at least one uplink wireless transmission parameter of an available wireless transmission resource on which feedback data for a control of the robotic device can be received. The apparatus may be configured to compare at least one of the obtained downlink wireless transmission parameter and the obtained uplink wireless transmission parameter with the wireless transmission requirement. For example, the apparatus is configured to compare all of the obtained wireless transmission parameters with the wireless transmission requirement.

In one variant, the apparatus is configured to determine the second movement instruction dependent on the at least one downlink wireless transmission parameter. For example, the at least one downlink wireless transmission parameter is at least one of a maximum update frequency supported by the available wireless transmission resource, and a minimal latency supported by the available wireless transmission resource.

According to one aspect, the apparatus is configured to determine the second movement instruction dependent on the at least one uplink wireless transmission parameter. The at least one uplink wireless transmission parameter for example indicates a bandwidth supported by the available wireless transmission resource.

In one variant, the feedback data are video data. For example, the feedback data is a video stream. The feedback data may be video data obtained by at least one camera-based sensor. The camera may be arranged on the robotic device (e.g., to move together with a robotic arm of the robotic device). Additionally or alternatively, the feedback data may be obtained by at least one camera arranged separately from the robotic device (e.g., which remains stationary relative to a robotic arm of the robotic device). The at least one uplink wireless transmission parameter may be indicative of at least one of the following: a maximum video frame rate supported by the available wireless transmission resource; a maximum video resolution supported by the available wireless transmission resource; and a maximum video quality supported by the available wireless transmission resource. The video quality may be indicative of a video compression rate.

The apparatus is for example configured to obtain the at least one downlink or uplink wireless transmission parameter, determine a relationship between the at least one downlink or uplink wireless transmission parameter and the at least one wireless transmission requirement and determine the second movement instruction based on the first movement instruction and the relationship. The determining of the relationship may be performed together with or before the step of determining that no wireless transmission resource is available which matches the wireless transmission requirement. For example, it is determined that no wireless transmission resource is available in case the relationship fulfills a predetermined criterion. Alternatively, it may be determined that no wireless transmission resource is available in case the relationship does not fulfill a predetermined criterion. In both alternative cases, the criterion may be that the relationship assumes a predefined value or falls within a predefined range of values.

In one example, the apparatus is configured to obtain at least two downlink or two uplink wireless transmission parameters, determine at least two relationships between the at least two downlink or two uplink wireless transmission parameters and at least two wireless transmission requirements, select one of the at least two relationships and determine the second movement instruction based on the first movement instruction and the selected relationship. In one variant, a relationship is determined between each of the obtained (downlink and/or uplink) wireless transmission parameters and the wireless transmission requirements. The relationship may be determined between an obtained wireless transmission parameter and a matching (i.e., corresponding) wireless transmission requirement. In other words, a type of the obtained wireless transmission parameter is for example equal to a type of the wireless transmission requirement upon determining the relationship between the obtained wireless transmission parameter and the wireless transmission requirement. Different wireless transmission requirement types include an update frequency (e.g., of movement control instructions, or commands, for the robotic device comprised in the control information), a frame rate, a latency, a video resolution and a video quality supported by the available wireless transmission resource.

The apparatus may be configured to select a most stringent one of the at least two relationships and determine the second movement instruction based on the first movement instruction and the selected relationship. The apparatus may be configured to determine which is the most stringent one based on predetermined selection criteria. The selection criteria may indicate a selection of a largest or a smallest relationship.

For example, each relationship is a proportion (e.g., a ratio) between a downlink or an uplink wireless transmission parameter (e.g., of an available wireless transmission resource) on the one hand and a wireless transmission requirement on the other hand. The wireless transmission requirement may be a numerical value. According to one aspect, a first proportion is a quotient between a downlink or an uplink wireless transmission parameter and a wireless transmission requirement. A second proportion may be a quotient between a wireless transmission requirement and a downlink or an uplink wireless transmission parameter. For example, at least one first relationship is the first proportion and at least one second relationship is the second proportion.

The at least one wireless transmission requirement is for example at least one of the following: a condition related to an update frequency supported by a wireless transmission resource; a condition related to a latency supported by a wireless transmission resource; a condition related to a frame rate supported by a wireless transmission resource; a condition related to a video resolution supported by a wireless transmission resource; and a condition related to a video quality supported by a wireless transmission resource. As noted above, the wireless transmission resource may correspond to a wireless transmission channel.

The apparatus may be configured to determine the at least one relationship or the at least two relationships by comparing the condition related to an update frequency supported by a wireless transmission resource with the maximum update frequency supported by the available wireless transmission resource. The apparatus may be configured to determine the at least one relationship or the at least two relationships by dividing a desired minimal update frequency supported by a wireless transmission resource with the maximum update frequency supported by the available wireless transmission resource. In this case, the condition related to the update frequency corresponds to the desired minimal update frequency.

In one variant, the apparatus is configured to determine the at least one relationship or the at least two relationships by comparing the condition related to a latency supported by a wireless transmission resource with the minimal latency supported by the available wireless transmission resource. According to one aspect, the apparatus is configured to determine the at least one relationship or the at least two relationships by dividing a desired minimal latency supported by a wireless transmission resource with the minimal latency supported by the available wireless transmission resource. In this case, the condition related to the latency corresponds to the desired minimal latency.

For example, the apparatus is configured to determine the at least one relationship or the at least two relationships by comparing the condition related to a frame rate supported by a wireless transmission resource with the maximum frame rate supported by the available wireless transmission resource. In one example, the apparatus is configured to determine the at least one relationship or the at least two relationships by dividing the desired minimum frame rate supported by a wireless transmission resource with the maximum frame rate supported by the available wireless transmission resource. In this case, the condition related to the frame rate corresponds to the desired minimum frame rate. The frame rate may be a video frame rate.

As noted above, the at least one first movement instruction in one example comprises a movement control command associated with the first point in time and the at least one second movement instruction may comprise a movement control command associated with the second point in time different from the first point in time (in particular later than the first point in time).

The apparatus is for example configured to determine the second control information by determining the second point in time. It may determine the second point in time by scaling the first point in time with the relationship or the selected relationship. For example, the first point in time is divided by the relationship or the selected relationship to determine the second point in time. The first point in time may be divided by the (e.g., selected) proportion to determine the second point in time.

In one variant, the second control information comprises the at least one uplink wireless transmission parameter. The at least one uplink wireless transmission parameter may be used by the apparatus to obtain the feedback data on a wireless transmission resource that matches the at least one uplink wireless transmission parameter. In other words, the robotic device may provide the feedback data on a wireless transmission resource which matches the at least one uplink wireless transmission parameter.

The feedback data may be determined based on the at least one uplink wireless transmission parameter comprised in the second control information. For example, the robotic device is configured to determine the feedback data based on the at least one uplink wireless transmission parameter. In one variant, at least one of a video resolution, a video frame rate and a video quality is controlled to match the at least one uplink wireless transmission parameter, in order to determine the feedback data.

The robotic device may comprise a robotic arm. The first movement instruction and the second movement instruction for example relate to different movements of the robotic arm. The movements may differ in regard to the time needed to complete the movements. The spatial movement trajectories resulting from the first movement instruction and the second movement instruction may be the same. The robotic device in one variant comprises a robotic arm which comprises multiple independently actuatable joints. The first movement instruction and the second movement instruction may each comprise movement control commands for actuation of different ones of the actuatable joints.

According to a second aspect, a method for determining control information to be wirelessly transmitted to a robotic device is provided. The method comprises obtaining first control information comprising at least one first movement instruction for a trajectory of the robotic device and obtaining an indication of at least one wireless transmission requirement for a wireless transmission resource, and determining that no wireless transmission resource of the robotic device is available which matches the wireless transmission requirement. The method further comprises determining second control information based on the first control information, wherein the second control information comprises at least one second movement instruction for the trajectory which is different from the at least one first movement instruction. In addition, a step of triggering wireless transmission of the second control information to the robotic device is comprised in the method.

The method presented therein may be performed by an apparatus as generally described above and as described below in more detail.

Also provided is a computer program comprising instructions which, when the program is executed by a processor, cause the processor to carry out the method presented herein. The computer program may also be provided for download via a network connection. Furthermore, a computer-readable medium comprising the computer program is provided, and a data carrier signal carrying information which represents the computer program.

Also presented is a cloud computing system configured to perform any of the method aspects presented herein. The cloud computing system may comprise distributed cloud computing resources that jointly perform the method presented herein under control of one or more computer program products. For example, the apparatus presented herein may be a part of the cloud computing system.

### BRIEF DESCRIPTION OF THE DRAWINGS

Further aspects, details and advantages of the present disclosure will become apparent from the detailed description of exemplary embodiments below and from the drawings, wherein:

FIGS. 1A & B illustrate network system embodiments of the present disclosure;

FIGS. 2A & B illustrate controller embodiments of the present disclosure; and

FIG. 3 illustrates a method embodiment of the present disclosure;

FIG. 4 illustrates a further method embodiment of the present disclosure; and

FIG. 5 illustrates a further network system embodiment of the present disclosure.

### DETAILED DESCRIPTION

In the following description, for purposes of explanation and not limitation, specific details are set forth in order to provide a thorough understanding of the present disclosure. It will be apparent to one skilled in the art that the present disclosure may be practiced in other embodiments that depart from these specific details.

While, for example, the following description focuses on specific radio access network types such as 5^{th} Generation (5G) networks, the present disclosure can also be to implemented in connection with other radio access network types. Moreover, while certain aspects in the following description will exemplarily be described in connection with cellular networks, particularly as standardized by 3GPP, the present disclosure is not restricted to any specific wireless access type.

Those skilled in the art will further appreciate that the steps, services and functions explained herein may be implemented using individual hardware circuitry, using software functioning in conjunction with a programmed microprocessor or general purpose computer, using one or more Application Specific Integrated Circuits (ASICs) and/or using one or more Digital Signal Processors (DSPs). It will also be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

In the following description of exemplary embodiments, the same reference numerals denote the same or similar components.

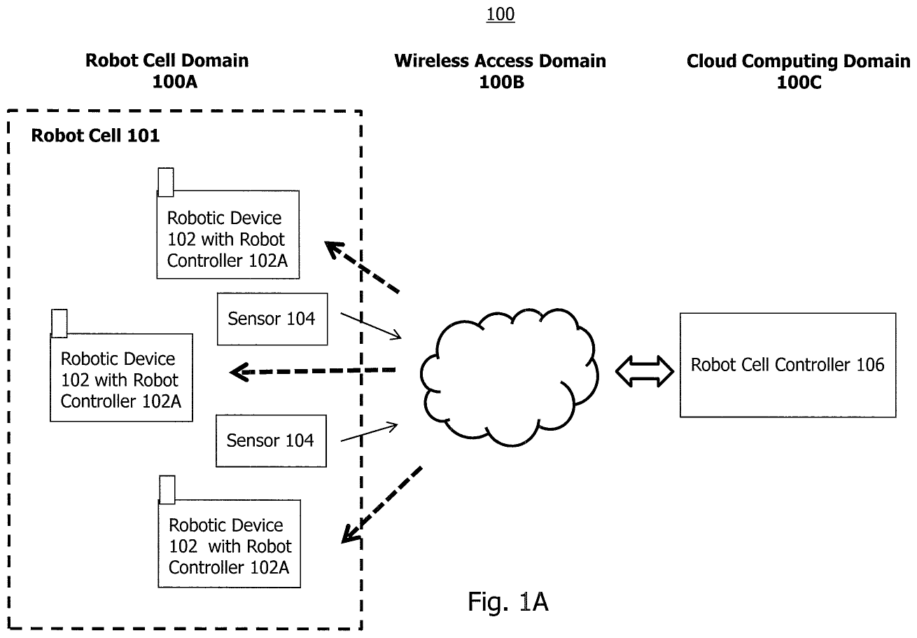

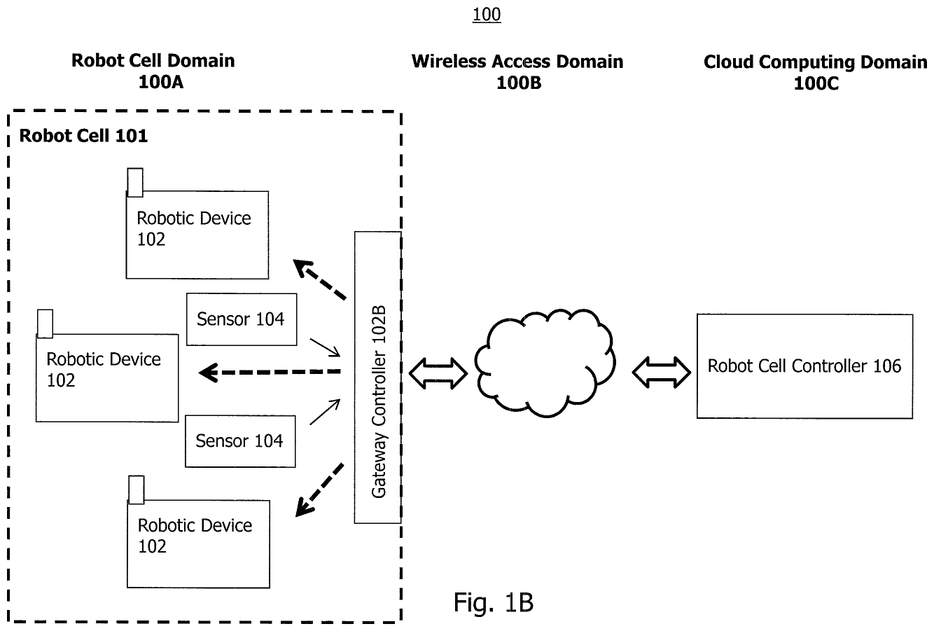

FIG. 1A illustrates an embodiment of a network system 100 for computing cloud-based robot cell control. As shown in FIG. 1A, the network system 100 comprises a robot cell domain 100A, a wireless access domain 100B as well as a cloud computing domain 100C.

The robot cell domain 100A comprises at least one robot cell 101 with multiple robotic devices 102 each having a dedicated robot controller 102A in association therewith. The robotic devices 102 can comprise various actuators such as robot arms movable within various degrees of freedom. The various robotic devices 102 within the robot cell 101 may collaboratively work on the same task (e.g., on the same work product).

The robot cell domain 100A further comprises multiple sensors 104 such as cameras, position sensors, orientation sensors, angle sensors, and so on. The sensors 104 generate sensor data indicative of a state of the robot cell 101 (i.e., cell state data). The sensors 104 can be freely distributed in the robot cell 101. One or more of the sensors 104 can also be integrated into one or more of the robotic devices 102. The sensors 104 provide feedback data for a control of at least one of the robotic devices 102.

At least one of the sensors 104 may be a camera. In robotics, visual servoing, also known as vision-based control, is a technique which uses feedback information extracted from a vision sensor such as a camera (visual feedback) to control the motion(s) of one or more of the robotic devices 102. There are two fundamental configurations: eye-in-hand, where the camera 104 is attached to a robotic arm of the robotic device 102 and configured to observe a relative position of a target, and eye-to-hand, where the camera 104 is fixed relative to the robotic arm and configured to observe a target and a motion of the robotic arm 102.

The wireless access domain 100B may be a cellular or non-cellular network, such as a cellular network specified by 3GPP. In some implementations, the wireless access domain 100B may be compliant with the 3GPP standards according to Release R15, such as TS 23.503 V15.1.0 (2018-3) or later. The wireless access domain 100B may comprise a base station or a wireless access point (not shown) that enables a wireless communication between components of the robot cell 101 on the one hand and the cloud computing domain 100C on the other via the wireless access domain 100B.

As illustrated in FIG. 1A, the robotic devices 102 with their associated robot controllers 102A are configured to receive control information generated in the cloud computing domain 100C via wireless transmissions from the wireless access domain 100B on an available wireless transmission resource. The control information includes movement instructions for a movement trajectory of at least one of the robotic devices 102. Moreover, the feedback data as acquired by the sensors 104 are wirelessly communicated on an available wireless transmission resource of the wireless access domain 100B to the cloud computing domain 100C to inform same about the state of the robot cell 101. Processing of the feedback data (e.g., in the context of inverse kinematics) at least partially takes place in the cloud computing domain 100C. The processed feedback data may then form the basis for movement instruction generation in the computing cloud domain 100C. Additionally, or in the alternative, movement instruction generation in the cloud computing domain 100C is based on actions defined in an action plan for one or more of the robotic devices 102.

The cloud computing domain 100C comprises a robot cell controller 106 composed of could computing resources. The robot cell controller 106 is configured to receive the feedback data (i.e., cell state data) from the sensors 104 via the wireless access domain 100B on an available wireless transmission resource (e.g., an available uplink channel). The robot cell controller 106 is further configured to obtain (e.g., generate) first control information comprising at least one first movement instruction for a trajectory of a robotic device 102 and to determine second control information comprising at least one second movement instruction of the trajectory which is different from the at least one first movement instruction in that an execution time of the trajectory is changed.

The controller 106 is further configured to trigger transmission of the second control information on an available wireless transmission resource (e.g., an available downlink channel) via the wireless access domain 100B to one or more of the robot controllers 102A of the robotic devices 102. The robot controllers 102A are configured to wirelessly receive the second control information with the second movement instruction and to control one or more individual actuators of the respective robotic device 102 based thereon.

AS said, one or more of the robotic devices 102 may comprise a robotic arm. The first movement instruction and the second movement instruction in such a case relate to different movements of the robotic arm with respect to a desired trajectory. The different movements may in particular differ in the time required to complete the trajectory.

The robotic arm comprises multiple independently actuatable joints that define individual degrees of freedom for robot arm movement. As understood herein, a movement instruction or a movement control command may pertain to the robot arm as a whole (and may thus comprise multiple sub-commands for the individual joint actuators), or it may pertain to an individual joint actuator of a multi-joint robot arm. A movement instruction or a movement control command pertaining to a robot arm movement may thus result in an action corresponding to a particular robot arm movement.

FIG. 1B illustrates an embodiment of a further network system 100 similar to the one shown in FIG. 1A. In the network system 100 of FIG. 1B, the local robot controllers 102A of FIG. 1A are replaced by a central gateway controller 102B. This gateway controller 102B is configured to wirelessly receive the control commands from the wireless access domain 100B and to control one or more individual actuators of each of the robotic devices 102 in the robot cell 101 based thereon. The connections between the gateway controller 102B and the robotic devices 102 may be wire-based (e.g., based on field buses). Using a central gateway controller 102B, a synchronous control of interworking robotic devices 102 becomes easier. The gateway controller 102B also collects the feedback data from the sensors 104 and wirelessly transmits same to the computing cloud domain 100C. The connections between the gateway controller 102B and the sensors 104 may be wire-based (e.g., based on field buses).

The network embodiments illustrated in FIGS. 1A and 1B can be combined in various ways. For example, each robotic device 102 may comprise an associated robot controller 102A as illustrated in FIG. 1A, and the robot controllers 102A may be attached to the gateway controller 102B of FIG. 1B using wire-based connections (e.g., field buses).

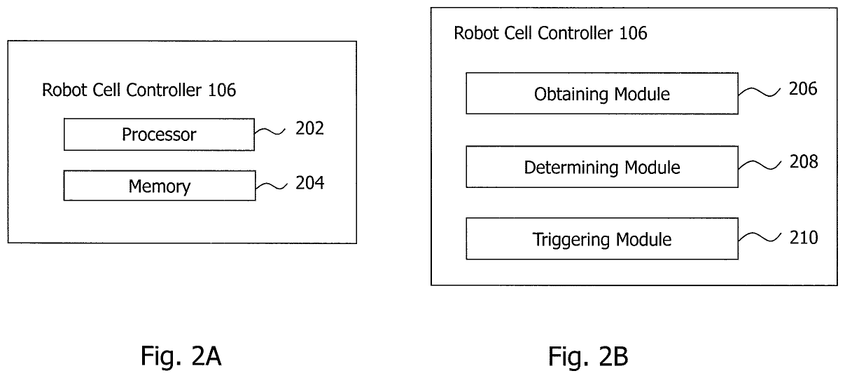

FIGS. 2A and 2B illustrate two embodiments of the computing cloud-based robot cell controller 106 of FIGS. 1A and 1B. In the embodiment illustrated in FIG. 2A, the cloud-based robot cell controller 106 comprises a processor 202 and a memory 204 coupled to the processor 202. Optionally, the controller 106 further comprises one or more interfaces for communication with other components of the network system 100 of FIGS. 1A and 1B, in particular with the wireless access domain 100B.

The processor 202 is configured to obtain first control information comprising at least one first movement instruction for a trajectory of one of the robotic devices 102 and to obtain an indication of at least one wireless transmission requirement for a transmission resource. The first control information (i.e., the first movement instruction) and the indication may be received together in a single message or separately in different messages such that the first control information and the indication can be interrelated.

The processor 202 is further configured to determine that no wireless transmission resource is available which matches the wireless transmission requirement. The processor 202 is further configured to determine second control information based on the first control information, wherein the second control information comprises at least one second movement instruction for the trajectory which is different from the at least one first movement instruction and to trigger wireless transmission of the second control information to the one of the robotic devices 102.

FIG. 2B shows an embodiment in which the computing cloud-based robot cell controller 106 is implemented in a modular configuration. As shown in FIG. 2B, the controller 106 comprises a obtaining module 206 configured to obtain first control information comprising at least one first movement instruction for a trajectory of one of the robotic devices 102 and to obtain an indication of at least one wireless transmission requirement for a transmission resource. The controller 106 further comprises a determining module 208 configured to determine that no wireless transmission resource is available which matches the wireless transmission requirement and to determine second control information based on the first control information, wherein the second control information comprises at least one second movement instruction for the trajectory which is different from the at least one first movement instruction. The controller 106 further comprises a triggering module 210 configured to trigger wireless transmission of the second control information to the one of the robotic devices 102.

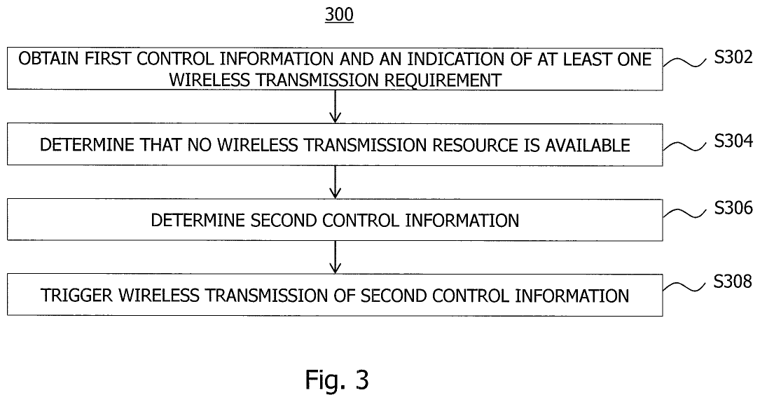

FIG. 3 illustrates in a flow diagram 300 a method embodiment of determining control information to be wirelessly transmitted to a robotic device 102. The method embodiment may be performed by any of the controllers 106 of FIG. 2A or 2B, or by a controller having a different configuration.

In step S302, the controller 106, obtains first control information. The first control information comprises at least one first movement instruction for a trajectory of at least one of the robotic devices 102. The first movement instruction comprises a movement control command associated with a first point in time. The movement control command may describe a position, a velocity or an acceleration of the robotic device 102 associated with the first point in time.

In the same step S302, the controller 106 obtains an indication of at least one wireless transmission requirement for a wireless transmission resource (i.e., a wireless transmission channel) of wireless access domain 100B intended for transmission of the first movement instruction. The at least one wireless transmission requirement is for example at least one of the following:
a desired minimal update frequency of feedback data to be received by controller 106 or of second control information to be transmitted to robotic device 102, which update frequency is supported by a wireless transmission resource of wireless access domain 100B;
a desired maximum latency supported by a wireless transmission resource of wireless access domain 100B;
a desired minimal video frame rate of a camera-based sensor 104 as supported by a wireless transmission resource of wireless access domain 100B;
a desired minimal video resolution of a camera-based sensor 104 as supported by a wireless transmission resource of wireless access domain 100B; and
a desired minimal video quality of a camera-based sensor 104 as supported by a wireless transmission resource of wireless access domain 100B.

In one example, the first control information is determined by the controller 106. The determined first control information can be stored by controller 106 in a data storage and may afterwards be obtained from the data storage. Alternatively, obtaining the first control information comprises generating the first control information.

In case the controller 106 determines the first control information, the first movement information comprised in the first control information corresponds to a “command” to be executed in the robot cell 101. The at least one wireless transmission requirement comprised in the first control information may correspond to a “setting of at least one transmission parameter”. This transmission parameter setting may be based on QoS control in accordance with 3GPP TS 23.501 (see, e.g., section 4.3 of V15.1.0 (2018-03)). The at least one wireless transmission requirement may be defined by an associated transmission resource consumption level. It may be defined by an associated Quality of Service, QoS, level of a wireless transmission channel. The QoS level may, for example, pertain to QoS control at a service data flow level, at a QoS flow level, or at a packet data unit session level (see, e.g., section 4.3.3 of 3^{rd} Generation Partnership Project (3GPP) Technical Specification (TS) 23.503 V15.1.0 (2018-3)).

In step S304, the controller 106 determines that no wireless transmission resource is available in the wireless access domain 100B which matches the transmission requirement. This is done by obtaining at least one downlink wireless transmission parameter of an available wireless transmission resource on which the second control information can be transmitted. The at least one downlink wireless transmission parameter is, for example, a maximum update frequency supported by the available wireless transmission resource of wireless access domain 100B or a minimal latency supported by the available wireless transmission resource of wireless access domain 100B. Alternatively or additionally, at least one uplink wireless transmission parameter of an available wireless transmission resource on which the feedback data for a control of the at least one robotic device 102 can be received may be obtained.

In some embodiments, the sensors 104 are video cameras and the feedback data are video data. In such cases, the at least one uplink wireless transmission parameter may indicate a bandwidth supported by the available wireless transmission resource of the wireless access domain 100B and may be indicative of at least one of the following:
a maximum video frame rate supported by the available wireless transmission resource of wireless access domain 100B;
a maximum video resolution supported by the available wireless transmission resource of wireless access domain 100B; and
a maximum video quality supported by the available wireless transmission resource of wireless access domain 100B.

Subsequently, at least one of the obtained downlink wireless transmission parameter and the obtained uplink wireless transmission parameter are compared with the wireless transmission requirement to determine that no wireless transmission resource is available which matches the wireless transmission requirement. As an example, the available uplink bandwidth may not support the desired video resolution as indicated by the wireless transmission requirement as obtained with the first control information.

In step S306, the controller 106 determines the second control information based on the first control information. The second control information comprises at least one second movement instruction for the trajectory which is different from the at least one first movement instruction in that an execution time of the trajectory is changed. In some cases, the second movement instruction may be determined dependent on the at least one downlink wireless transmission parameter. In the same or in other cases, the second movement instruction may be determined dependent on the at least one uplink wireless transmission parameter.

The second control information can be determined based on the at least one downlink wireless transmission parameter. In order to determine the second control information, the controller 106 obtains the at least one downlink wireless transmission parameter and determines a proportion between the at least one downlink wireless transmission parameter and the at least one wireless transmission requirement. The proportion is, for example, at least one of the following:
a proportion between the condition related to an update frequency supported by a wireless transmission resource and the maximum update frequency supported by the available wireless transmission resource; and
a proportion between the condition related to a latency supported by a wireless transmission resource and the minimal latency supported by the available wireless transmission resource.

The second control information can in addition or alternatively thereto be determined based on the at least one uplink wireless transmission parameter. The controller 106 may obtain the at least one uplink wireless transmission parameter and determine a proportion between the at least one uplink wireless transmission parameter and the at least one wireless transmission requirement. The proportion is, for example, a proportion between the condition related to a frame rate supported by a wireless transmission resource and the maximum frame rate supported by the available wireless transmission resource.

Subsequently, the controller 106 determines the second movement instruction based on the first movement instruction and the proportion. In more detail, the at least one first movement instruction comprises a first movement control command associated with the first point in time and the at least one second movement instruction comprises a second movement control command associated with a second point in time different from the first point in time. The controller 106 is configured to determine the second control information by determining the second point in time by scaling the first point in time with the proportion or the selected proportion.

In case a plurality of downlink or uplink wireless transmission parameters are obtained by the controller 106, the controller 106 determines at least two proportions between the downlink and uplink wireless transmission parameters on the one side and at least two wireless transmission requirements on the other side. Subsequently, the controller 106 selects a most stringent one of the determined proportions and determines the second movement instruction based on the first movement instruction and the selected proportion. In particular, the controller 106 determines which is the most stringent one based on predetermined selection criteria. The selection criteria may indicate a selection of a largest relationship or generally a relationship with the strictest transmission requirements.

In step S308, the controller 106 triggers wireless transmission of the second control information to at least one of the robotic devices 102. The second control information is transmitted on a wireless transmission resource of wireless access domain 10013. The second control information comprises the second movement instruction. After the at least one robotic device 102 in the robot cell domain 100A has received the second control information, it can execute the second movement instruction. In particular, it can execute the second movement control command associated with the second point in time, wherein the second movement control command is comprised in the second movement instruction. In other words, the trajectory can be executed by the at least one robotic device 102 with a different execution time compared to the movement instruction comprised in the first control information.

For example, the uplink wireless transmission parameter is transmitted together the second control information to robot cell domain 100A. The uplink wireless transmission parameter may be comprised in the second control information. The feedback data can be transmitted to the controller 106 on an available wireless transmission resource of wireless access domain 100B with the uplink wireless transmission parameter. That is, the sensors 104 determine the feedback data based on the uplink wireless transmission parameter. In a video camera-based feedback scenario, one or more of a video frame rate, a video resolution and a video quality can be adjusted by the sensors 104 before the feedback data is transmitted to the controller 106.

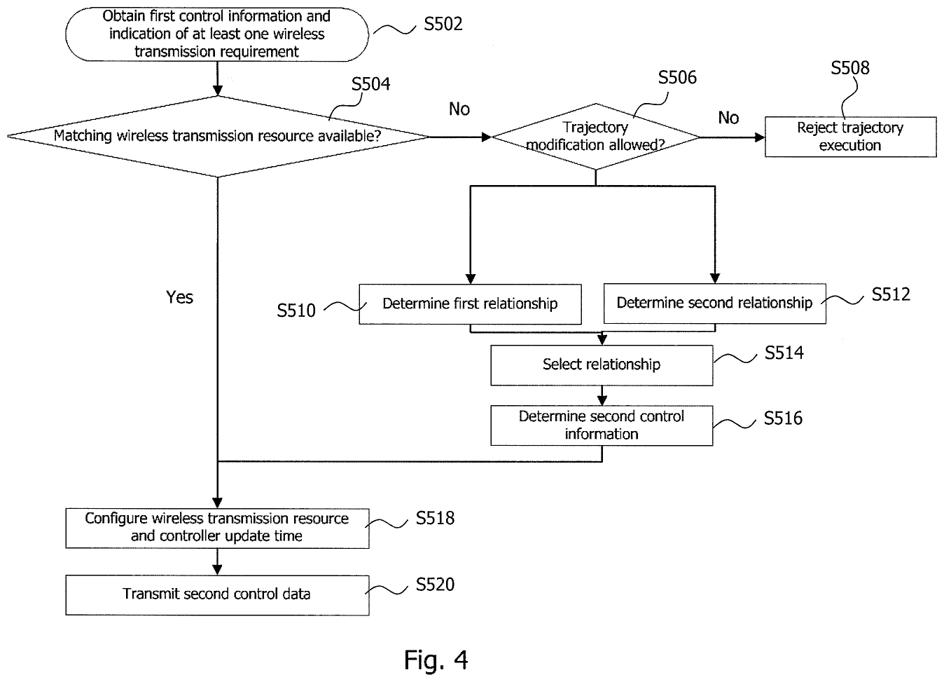

FIG. 4 shows a further method embodiment. This method embodiment illustrates in more detail some of the steps already discussed above with reference to FIG. 3.

In step S502, which corresponds to step S302 of FIG. 3, the first control information including the first movement instruction is obtained. Also, the indication of the at least one wireless transmission requirement is obtained. In subsequent step S504, which corresponds to step S304 of FIG. 3, it is determined whether a wireless transmission resource is available which matches the wireless transmission requirement. If it is determined that no such wireless transmission resource is available, the method proceeds to step S506.

In step S506, it is determined whether a modification of the trajectory is allowed. In one variant, it is determined whether a modification of the first movement instruction, which at least partially defines the trajectory, is permitted. For example, the first control information comprises an indication whether or not a modification of the first movement instruction is allowed. Alternatively, this indication may be obtained separately from the first control information. In case it is determined that the modification of the trajectory is not allowed, the method proceeds to step S508 and rejects a trajectory execution. In other words, no second control information is determined in case the method proceeds to step S508.

In case a trajectory modification is allowed, the method proceeds with steps S510 and S512, which can be considered to be comprised by step S306 of FIG. 3. Steps S510 and S512 may be performed in parallel or subsequently. In step S510, a first relationship is determined, whereas in step S512, a second relationship is determined. Either one of steps S510 and S512 may be omitted.

The first relationship is for example determined by dividing the desired update frequency, which is one exemplary wireless transmission requirement, by a maximum update frequency supported by the available wireless transmission resource, which is one exemplary downlink wireless transmission parameter. The second relationship may be determined by dividing a minimal latency supported by the available wireless transmission resource, which is another exemplary downlink wireless transmission parameter, by the desired latency, which is another exemplary wireless transmission requirement. A third relationship may be determined also. The third relationship is for example obtained by dividing the desired frame rate, which is a still further exemplary wireless transmission requirement, by a maximum frame rate supported by the available wireless transmission resource, which an exemplary uplink wireless transmission parameter. The one or more wireless transmission requirements may have been obtained in step S502 as part of the first control information.

In step S514, one of the determined relationships is selected. For example, the determined relationships are numerical values and the largest of the numerical values is selected.

In step S516, the second control information is determined based on the first control information and the selected relationship. In particular, the second movement instruction is determined based on the first movement instruction and the relationship selected in step S514. Steps S514 and S516 can be considered to be comprised by step S306 of FIG. 3.

The method then proceeds with step S518 in which the available wireless transmission resource is configured so as to transmit the second control data. In other words, a wireless transmission of the second control information is triggered in accordance with step S308 of FIG. 3. This may comprise selecting one of a plurality of available wireless transmission resources based on the at least one wireless transmission requirement. In addition, a controller update time may be configured. In other words, a frequency with which control information is to be transmitted from the controller 106 to the robotic device 102 is determined based on at least one of the first control information, the second control information and the selected relationship. For example, the frequency is determined based on at least one of the uplink wireless transmission parameter and the downlink wireless transmission parameter. The frequency may be selected according to the available wireless transmission resource. Alternatively or additionally, a frequency with which the feedback data is obtained may be controlled as the controller update time. This frequency may be determined based on the at least one uplink wireless transmission parameter.

In step S520, the second control data is transmitted from the controller 106 to the robotic device 102. For the transmission, the available wireless transmission resource is used. Note that in case it is determined in step S504 that a wireless transmission resource is available which matches the at least one wireless transmission requirement, the method directly proceeds from step S504 step S518.

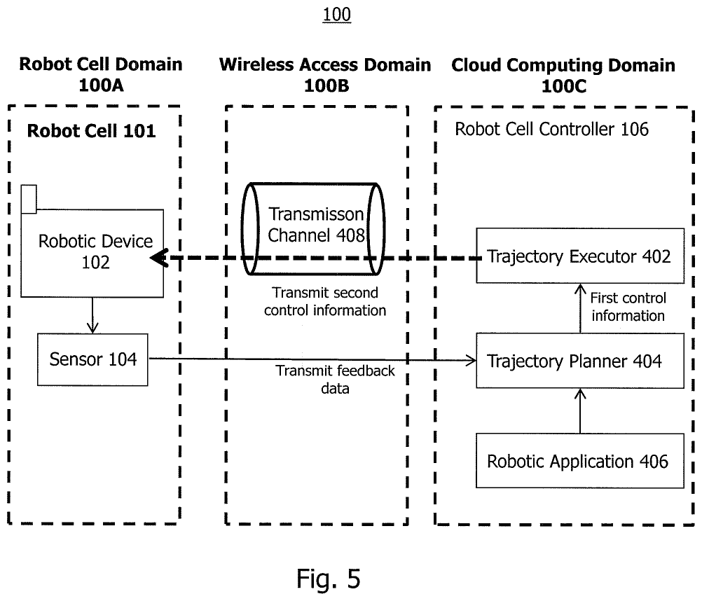

FIG. 5 illustrates a further network system embodiment that is based on the embodiments discussed above with reference to FIGS. 1A and 1B and 2 to 5.

As can be seen in FIG. 5, the controller 106 comprises a trajectory executor 402, a trajectory planner 404 and a robotic application 406. The transmission channel 408 corresponds to the available wireless transmission resource. The sensor 104 is, as described above, a video camera configured to transmit feedback data to the cloud computing domain 100C. In case of an eye-in-hand configuration or end-point closed-loop control, the camera 104 is attached to the moving robotic arm and observing the relative position of a work target. In case of an eye-to-hand configuration or end-point open-loop control, the camera 104 is stationary in the robot cell 101 and observing the target and the motion of the robotic arm.

The trajectory planner 404 receives the feedback data from the camera 104. The camera 104 may be connected to a video encoder (not shown). A compressed video stream can be transmitted as the feedback data to the trajectory planner 404 over wireless access domain 100B. In addition, the trajectory planner 404 obtains data from robotic application 406 which indicates a desired trajectory of the robotic device 102. Based on the feedback data and the desired trajectory of the robotic device 102, the trajectory planner 404 determines the first control information. In other words, the trajectory planner 404 assigns an indication of at least one wireless transmission requirement to each calculated trajectory and sends it to trajectory executor 402. In particular, the trajectory planner 404 determines the first movement instruction, the at least one wireless transmission requirement and an indication whether a modification of the trajectory is allowed or not. The trajectory planner 404 controls the compression parameters of the video streams by determining the at least one wireless transmission requirement.

The trajectory executor 404 determines whether a wireless transmission resource is available based on the desired and available wireless transmission resources. The trajectory planner 404 processes the incoming video streams (feedback data) and updates the calculated trajectory by determining the at least one first movement instruction. The trajectory planner 404 configures the camera 104 or the video encoders of the camera 104 by determining the at least one wireless transmission requirement. The at least one wireless transmission requirement may be determined based on the first movement instruction and a finding of a feasible wireless connection setting for the video streams. The requirement for the wireless transmission resource may correspond to the uplink wireless transmission parameter. The requirement for the wireless transmission resource may be comprised in the second control information. Accordingly, the video encoder or the camera 104 can be configured transmit the feedback data with the uplink wireless transmission parameter, for example with a certain video frame rate.

The trajectory planner 404 may determine the desired wireless network configuration based on the need and/or type of input task, thereby determining the at least one wireless transmission requirement to determine the first movement instruction, the trajectory planner 404 may compare a momentary position, velocity or acceleration of the robotic device 102 with the desired trajectory obtained from the robotic application 406. The trajectory planner 404 generates the first movement instruction using kinematics calculations and by processing the incoming video streams.

By a slow-down of the execution time of the trajectory described by the first control information, an update frequency and a latency are relaxed at the cost of trajectory execution time by keeping the original execution accuracy. For example, in a pick-and-place use case, such slow-down of the trajectory can be used, however in case of painting the slow-down of the trajectory should be avoided. In a cooperative use-case where two or more robot arms work on the same object, all trajectories should be slowed-down by the same relationship if needed or slow-down should be avoided. For a slower trajectory, the same trajectory execution quality (excluding execution time) can be achieved over a less demanding wireless connection.

In the following, several examples of how the trajectory planner 404 determines the at least one wireless transmission requirement are given.

For tasks that require high spatial and/or timing accuracy, a fast update is needed for the control and a high resolution and/or quality and a high frame rate video is needed for the trajectory update, i.e., the determination of the first movement instruction. In this case, a low latency is set as requirement for the (downlink) wireless transmission resource, and a high bandwidth is set as requirement for the (uplink) wireless transmission resource.

For tasks with regular movements, a slower update time is needed for the control and a lower resolution and/or quality video with lower frame rate is enough for the trajectory update. A relaxed latency is set as requirement for the (downlink) wireless transmission resource, and a lower bandwidth is set as requirement for the (uplink) wireless transmission resource.

For example, moving a robot arm to a waiting position (e.g., waiting for a next task and not disturbing movements of other robotic devices) does not require a high accuracy and thus the corresponding movement can be slowed-down. For example, a slow update time (e.g., 100 ms) and a relaxed desired latency (e.g., 10 ms) can be specified as the requirement of the wireless transmission resource and slow-down of the trajectory can be allowed. For the video stream as feedback data, a low frame rate (10 fps) and a low resolution and/or quality (720p, ˜0.5 Mb/s) is enough to find the position and may thus be set as the requirement for the uplink wireless transmission resource.

For pick-and-place use-cases, a normal accuracy is required and slow-down of the movement is also tolerable. High resolution and high-quality video is required to position the robotic arm with a normal frame rate. For example, 8 ms update time and 2 ms latency, with 1080p video with 30 fps or a lower frame rate is required, if slow-down is in effect.

For painting, a normal accuracy is enough, but slow-down of a movement is not allowed. For example, 8 ms update time and 2 ms latency with 1080p video with 30 fps and disabled slow-down is required.

For welding, high accuracy is required and slow-down of a movement is not allowed to get a high quality welding seam. For example, 2 ms update time and 0.5 ms latency with 1080p video with 60 fps or higher (if the camera 104 supports it) and disabled slow-down is required.

An original trajectory as defined in the first control information discussed above and describing at least one of a position “positionOld”, a velocity “velocityOld” and an acceleration “accelerationOld” can be slowed down by determining at least one of a position “position New”, a velocity “velocityNew” and an acceleration “accelerationNew” of a new trajectory at a point in time “t” (i.e., the second control information discussed above) based on the (selected) relationship “sR” as follows:

positionNew(t)=positionOld(t/sR);

velocityNew(t)=velocityOld(t/sR)/sR;

accelerationNew(t)=accelerationOld(t/sR)/sR/sR.

The second movement instruction in the second control information may then comprise at least one of positionNew(t), velocityNew(t) and accelerationNew(t). The trajectory execution time increases from a total time T1 to a total time T2=T1*sR.

The trajectory executor 402 may determine “desiredupdateFrequencyNew” as a desired update frequency of the new trajectory, based on the desired update frequency of the old trajectory “desiredupdateFrequencyOld” as follows:

desiredupdateFrequencyNew=desiredUpdateFrequencyOld/sR.

The trajectory executor 402 for example determines a desired latency “desiredlatencyNew” of the new trajectory based on the desired latency “desiredlatencyOld” as follows:

desiredlatencyNew=desiredLatencyOld*sR.

Both the determined desiredupdateFrequencyNew and the determined desiredlatencyNew may be used in step S518 of the method described above to configure the available wireless transmission resource and the controller update time. For example, the desiredupdateFrequencyNew is set as the controller update time. The desiredlatencyNew may be set as a wireless transmission requirement comprised in the second control information.

An optimal setting of proportional-integral-derivative (PID) control in controller 106 may be maintained by trajectory execution for each potential update frequency/latency combination. The optimal values can be determined by mathematical, simulation or measurement-based optimization method. For each trajectory, namely for each determined second movement instruction, the corresponding PID settings are configured and used.

The embodiments described above may be implemented in the context of adaptive visual servoing. Video compression may be performed in accordance with the uplink wireless transmission parameter comprised in the received second control information. A trajectory-based robotic arm control update time, i.e., an adjustment of the execution time of the trajectory, makes the robotic cell operation more robust and efficient over wireless connection. The controller 106 may be configured to adjust a time interval at which control information is transmitted to the robotic device 102 based on the second control information, in particular based on the execution time of the trajectory of the second movement instruction.

The wireless transmission requirement may be specified for each trajectory, for example for each determined second movement instruction, separately. It may be determined by the robotic application 406 based on the specific task of the robotic arm.

The first control information may comprise the at least one wireless transmission requirement of the video frame rate, the video resolution and the video (compression) quality. These may be used to configure the wireless (uplink) connection. Alternatively, the at least one wireless transmission requirement may be obtained as a message separately from the first control information.

The wireless transmission requirement may correspond to properties of the transmission of the second control information or the feedback data, such as a desired minimal command and/or status frequency (desired minimal update frequency on the downlink and/or uplink, respectively) and a desired maximum tolerated communication latency (desired maximum latency). These may be used to configure the controller update time and the wireless connection.

The first control information may further comprise an indication whether trajectory slow-down (i.e., the determination of the second movement instruction different from the first movement instruction) is allowed or not. The indication may be determined by the robotic application 406 depending on the specific task of the robotic arm (i.e., a pick-and-place task allows, but a painting/welding task does not allow trajectory slow-down).

Trajectory slow-down allows more room for the controller 106 to find a feasible (i.e., optimal) communication channel setting. In other words, the determination of the second movement instruction different from the first movement instruction allows the selection of an available wireless transmission channel for transmitting the second control command, which wireless transmission channel would not be suitable for transmitting the first control command. In case the uplink wireless transmission parameter indicates a slow-down of the feedback data, some properties of the video capture and compression can be eased (for example, the frame rate can be lowered whilst the picture quality and, thus, the resolution are maintained) as the execution time of the trajectory is increased and velocity values of the robotic device 102 are scaled down. In other words, a robot arm would go along the same trajectory (i.e., path) but slower, which enables a lower video quality, frame rate or resolution to control the robotic device 102.

The trajectory executor 402 receives a current state of the robotic device 102 indicated by the feedback data and a desired trajectory indicated by the data obtained from the robotic application 406. First it tries to find a proper wireless connection or reconfigure an existing one if needed. In other words, it is determined whether an available wireless transmission resource is available which matches the at least one wireless transmission requirement. If there is no feasible connection and trajectory slow-down is allowed, then the trajectory is slowed down to match the best available wireless connection. In other words, it is determined that no wireless transmission resource is available which matches the wireless transmission requirement. Subsequently the second control information is determined based on the first control information and the (selected) relationship. The relationship is determined based on a wireless transmission parameter of an available wireless transmission resource and based on the wireless transmission requirement. If no feasible connection has been found after slow-down, the trajectory execution is rejected and the robotic application 406 is notified. In this case, no second movement instruction is comprised in the second control information. Instead, an error message may be comprised in the second control information, or the second control information may not be generated at all.

The technique presented herein may be implemented using a variety of robot programming tools and languages. For example, the robot programming language may be based on C++.

As has become apparent from the above exemplary embodiments, the technique presented herein permits to more efficiently use wireless transmission resources by intentionally adapting execution (e.g., execution speed) of a trajectory of a robotic device before wirelessly transmitting corresponding control information. By, for example, properly selecting the execution speed of the trajectory, properties of the available wireless transmission resources are taken into account. Trajectory-related information can thus be transmitted with a low rate of transmission errors on the available resources.

Vision sensors such as camera 104 of prior visual servoing systems are connected to a controller such as controller 106 directly or via a high bandwidth wired network. Video data is transmitted uncompressed or with low compression. Using this high bandwidth video data over a wireless connection can easily exceed the available wireless transmission resources. By using only the necessary configuration for video stream and robot control as described herein, usage of wireless transmission resources can be optimized.

Overall performance of the robotic cell control over the wireless access domain 100B can be improved by using the highest quality configuration for a downlink channel and an uplink channel that is necessary for a certain trajectory of a robotic device 102, e.g., the highest quality configuration for a feedback video stream and robot device control commands.

The allocation of the wireless resources is enabled on a trajectory level and therefore a fine grain allocation becomes possible. Furthermore, by including the uplink wireless transmission parameter in the transmitted second control information, the feedback data used to determine the control information for the robotic device can be obtained on available transmission resources with a low rate of transmission errors.

Additionally, legacy communication protocols, in particular those previously used in wire-based control systems, can remain unchanged. As such, a cost effective and efficient solution for the transition from wire-based to wireless command transmission technologies in industrial environments can be realized.

While the present disclosure has been described with reference to exemplary embodiments, it will be appreciated that the present disclosure can be modified in various ways without departing from the scoop of the present disclosure as defined in the appended claims.

1.-25. (canceled)

26. A controller for determining control information to be wirelessly transmitted to a robotic device, the controller comprising:
processing circuitry configured to:
obtain first control information comprising at least one first movement instruction for a trajectory of the robotic device and obtain an indication of at least one wireless transmission requirement for a wireless transmission resource;
determine that no wireless transmission resource is available which matches the wireless transmission requirement;
determine second control information based on the first control information, wherein the second control information comprises at least one second movement instruction for the trajectory which is different from the at least one first movement instruction; and
trigger wireless transmission of the second control information to the robotic device.

27. The controller of claim 26, wherein the second movement instruction is different from the first movement instruction in that an execution time of the trajectory is changed.

28. The controller of claim 26, the processing circuitry is configured to:
determine that no wireless transmission resource is available which matches the wireless transmission requirement by:
obtaining at least one of:
at least one downlink wireless transmission parameter of an available wireless transmission resource on which the second control information can be transmitted; and
at least one uplink wireless transmission parameter of an available wireless transmission resource on which feedback data for a control of the robotic device can be received; and
comparing at least one of the obtained downlink wireless transmission parameter and the obtained uplink wireless transmission parameter with the wireless transmission requirement.

29. The controller of claim 28, wherein the processing circuitry is configured to:
determine the second movement instruction dependent on the at least one downlink wireless transmission parameter.

30. The controller of claim 28, wherein the at least one downlink wireless transmission parameter is at least one of the following:
a maximum update frequency supported by the available wireless transmission resource; and
a minimal latency supported by the available wireless transmission resource.

31. The controller of claim 28, wherein the processing circuitry is configured to:
determine the second movement instruction dependent on the at least one uplink wireless transmission parameter.

32. The controller of claim 28, wherein the at least one uplink wireless transmission parameter indicates a bandwidth supported by the available wireless transmission resource.

33. The controller of claim 28, wherein the feedback data is video data and the at least one uplink wireless transmission parameter is indicative of at least one of the following:
a maximum video frame rate supported by the available wireless transmission resource;
a maximum video resolution supported by the available wireless transmission resource; and
a maximum video quality supported by the available wireless transmission resource.

34. The controller of claim 28, wherein the processing circuitry is configured to:
obtain the at least one downlink or uplink wireless transmission parameter;
determine a relationship between the at least one downlink or uplink wireless transmission parameter and the at least one wireless transmission requirement; and
determine the second movement instruction based on the first movement instruction and the relationship.

35. The controller of claim 28, wherein the processing circuitry is configured to:
obtain at least two downlink or two uplink wireless transmission parameters;
determine at least two relationships between the at least two downlink or two uplink wireless transmission parameters and at least two wireless transmission requirements;
select one of the at least two relationships; and
determine the second movement instruction based on the first movement instruction and the selected relationship.

36. The controller of claim 35, wherein the processing circuitry is configured to:
select a most stringent one of the at least two relationships and determine the second movement instruction based on the first movement instruction and the selected relationship.

37. The controller of claim 35, wherein each relationship is a proportion between a downlink or an uplink wireless transmission parameter and a wireless transmission requirement.

38. The controller of claim 35, wherein the processing circuitry is configured to determine the at least one relationship or the at least two relationships by performing at least one of the following steps:
comparing the condition related to an update frequency supported by a wireless transmission resource with a maximum update frequency supported by the available wireless transmission resource;
comparing the condition related to a latency supported by a wireless transmission resource with a minimal latency supported by the available wireless transmission resource; and
comparing the condition related to a frame rate supported by a wireless transmission resource with a maximum frame rate supported by the available wireless transmission resource.

39. The controller of claim 35, wherein:
the at least one first movement instruction comprises a first movement control command associated with a first point in time; and
the at least one second movement instruction comprises a second movement control command associated with a second point in time different from the first point in time.

40. The controller of claim 39, wherein the processing circuitry is configured to determine the second control information by determining the second point in time by scaling the first point in time with the relationship or the selected relationship.

41. The controller of claim 28, wherein the second control information comprises the at least one uplink wireless transmission parameter.

42. The controller of claim 26, wherein the at least one wireless transmission requirement is at least one of the following:
a condition related to an update frequency supported by a wireless transmission resource;
a condition related to a latency supported by a wireless transmission resource;
a condition related to a frame rate supported by a wireless transmission resource;
a condition related to a video resolution supported by a wireless transmission resource; and
a condition related to a video quality supported by a wireless transmission resource.

43. The controller of claim 26, wherein the robotic device comprises a robotic arm and wherein the first movement instruction and the second movement instruction relate to different movements of the robotic arm.

44. The controller of claim 26, wherein the robotic device comprises a robotic arm comprising multiple independently actuatable joints, and wherein the first movement instruction and the second movement instruction each comprise movement control commands for actuation of different ones of the actuatable joints.

45. A method for determining control information to be wirelessly transmitted to a robotic device, the method comprising:
obtaining first control information comprising at least one first movement instruction for a trajectory of the robotic device and obtaining an indication of at least one wireless transmission requirement for a wireless transmission resource;
determining that no wireless transmission resource of the robotic device is available which matches the wireless transmission requirement;
determining second control information based on the first control information, wherein the second control information comprises at least one second movement instruction for the trajectory which is different from the at least one first movement instruction; and
triggering wireless transmission of the second control information to the robotic device.
